(19) United States
(12) Patent Application Publication
(10) Pub. No.: US 2013/0153118 A1
(43) Pub. Date: Jun. 20, 2013

(54) PHOSPHORESCENT COMPOSITIONS AND USE THEREOF

(71) Applicant: Diana FRIEDRICH, Irsee (DE)

(72) Inventor: Diana FRIEDRICH, Irsee (DE)

(21) Appl. No.: 13/818,451

(22) PCT Filed: Aug. 29, 2011
(86) PCT No.: PCT/EP2011/064828

§ 371 Date: Feb. 22, 2013

(30) Foreign Application Priority Data
Aug. 27, 2010 (DE) 10 2010 039 885.3

(51) Int. Cl. C09D 5/22; C09K 11/00

(52) U.S. Cl. CPC C09D 5/22; C09K 11/00
USPC 156/67; 252/301.4 R; 252/301.5; 524/494; 8/632; 8/552

(57) ABSTRACT

Disclosed is a phosphorescent composition which contains lead-free glass powder and phosphorescent pigment. The composition is in particular suitable for producing dyes, paints and glass articles.

The invention is directed to phosphorescent compositions as well as dyes and paints containing the same. The invention is further directed to articles, produced by the use of these compositions, dyes or paints, and a process for producing luminescent glass articles.

Phosphorescent pigments, also referred to as luminescent pigments, are insoluble in the medium of usage and have the property to be able to store incident light of the visible region and in particular the invisible region (UV region), and to release the stored energy in a time-delayed manner for a longer period of time in the form of visible light. Thus, phosphorescent pigments can be used for producing dyes and paints that luminesce in the dark and so-called “glow in the dark” articles. Thereby, phosphorescent or luminescent materials can be utilized for information, security or decoration purposes on various articles and surfaces, for instance as guiding marks for emergency exits and for the identification of steps of a staircase.

In order to achieve a strong and lasting luminescent effect, large amounts of these pigments are required, whereby the production of these products is expensive due to the high costs of the pigments. Moreover, the phosphorescent pigments have to be illuminated with light over a long period of time so as to achieve the desired luminescent effect, and the duration of time of luminescence is often short. In addition, conventional luminescent dyes and paints tend to depositing and clumping when applied to the substrate due to the high pigment content therein and may have an inhomogeneous and coarse-grained appearance. Furthermore, the dyes and paints often adhere poorly to substrates, such as glass, stone or textiles. Thereby, phosphorescent paintings on floor coverings are gradually removed due to wear or they weather. Luminescent adhesive materials or plastic strips, as they are used in lieu thereof for instance for marking of concrete, such as on steps of a staircase, are easily peeled off due to a strong wear and due to a poor adherence on the porous ground.

DE 23 61 569 A describes a signaling and warning material, which is prepared by using a mixture of fluorescent, phosphorescent and reflecting compounds. In this context, this reference also mentions surfaces having a reflecting effect, which surfaces are prepared from resins and crystalline compounds or glass powder. However, the drawback of compositions containing glass powder and phosphorescent compounds is that chemical reactions may occur, in particular upon contact with humidity, whereby harmful gases, such as hydrogen sulfide and sulfur dioxide, can be generated and/or which may cause color changes, the destruction of the pigments and eventually a complete loss of luminance.

EP 0 182 744 A describes photocurable epoxy resin compositions comprising an epoxy resin and a photoinitiator, and which may further contain fillers, such as electrically and thermally conductive fillers, ferroelectrics and phosphorescent fillers, and flow agents, such as glass powders, wherein the flow agents are merely used in case of ceramic applications. As far as glass powders are used, they are however only employed together with electrically conductive or dielectric fillers. There are described no examples that contain phosphorescent fillers and glass powder.

WO 2009/089920 describes phosphorescent concrete mixtures, comprising photoluminescent pigments. However, the use of thus produced concrete blocks, for instance in the field of floor coverings, is disadvantageous in that these blocks are very expensive due to the large amount of pigment material employed, because concrete is not translucent and consequently only the topmost cover layer of the block glows. Thus, at least 50% of the pigment material employed does not have any visible effect. The use of quartz powder as a transparency magnifier, as further described, is also very expensive.

Thus, the object of the present invention is to provide dyes, paints and articles that are luminescent in the dark and that have a good appearance and can be prepared in a cost-saving manner, wherein the pigments can be charged within a relatively short period of time and the dyes and articles possess a long duration of luminescence. A further object is to provide paints and dyes, in particular for spray coating, that can be used in the interior as well as in the outdoor area, that adhere to materials, such as textile, metal, stone, glass, plastics, concrete, wood and asphalt and that can be easily applied.

This object was solved by means of phosphorescent compositions according to the present invention that comprise:
(a) glass powder, the glass powder being lead-free glass powder, selected from lime soda glass, borosilicate glass, float glass and phosphate glass; and
(b) phosphorescent pigment.

Glass powder made of lime soda glass, borosilicate glass, float glass and phosphate glass regularly have a certain lead content due to the process by which they have been prepared and the additives used therein. It has now been found that compositions containing lead-free glass powder are stable for a longer period of time during storage and upon contact with moisture compared with compositions containing conventional lead-containing glass. Moreover, the compositions enable to considerably reduce the amount of phosphorescent pigment used without decreasing the duration of luminescence of those products that have been treated with the compositions according to the present invention. At the same time, the period of time can be decreased wherein the pigments have to be exposed to light so as to store sufficient energy. The compositions adhere well to substrates, such as glass and textile, and exhibit a good drying performance. Moreover, the products have a very homogeneous, fine-grained and bright appearance due to the presence of the glass powder.

It is preferred to use lead-free glass powder that is furthermore free of barium, arsenic and antimony, which are usually present in the raw material used for the production of glass or which are often used as a clearing agent in the course of the production of glass, for instance in the form of barium oxide or antimony oxide. Preferably, the iron content in the glass powder is 0.05 wt.-% or less, more preferred 0.01 wt.-% or less, based on the mass of the glass powder. Glass powder that is free of the aforesaid substances can be obtained by conventional processes for the production of glass, when attention is paid that the production of glass is carried out by means of raw materials free of said substances. Such glass is known in the prior art. For instance, lead-free and barium-free glass is described in WO 2005/090252.

By using lead-free glass powder made of lime soda glass, borosilicate glass, float glass and phosphate glass, the production costs can be further decreased. It is particularly preferred to use lime soda glass and borosilicate glass. Depending on the field of application, colored or colorless glass powders can be used. The density of the glass used is preferably within the range of from 2.3 to 2.8 g/cm³, particularly preferred within the range of from 2.4 to 2.7 g/cm³, for instance about 2.5 g/cm³.

The glass powder can be produced by grinding the respective glass. Preferably, the glass powder has a particle size d100 of 500 μm, i.e. 100 wt.-% of the glass powder particles may have a particle size up to 500 μm and there are no particles larger than 500 μm. Preferably, the glass powder has a particle size d100 of 350 μm. A single glass powder quality can be used as the glass powder or mixtures of two or more glass powder qualities having different particle sizes or particle size distributions can be used. Due to the finer grain size distribution obtained by the addition of glass powder to the phosphorescent pigment and due to the lower density of the glass in comparison with the phosphorescent pigment, the sedimentation of the pigment in dyes or paints because of its high specific density is diminished and slowed so that the powder mixture remains in suspension for a longer period of time and does not clump together at the bottom of the application machine so quickly. The particle sizes and particle size distributions can be determined by standardized methods by means of screen analysis according to DIN 66165-1 and 66165-2.

The glass powder is preferably contained in an amount of from 15 to 85 wt.-%, based on the total weight of the glass powder and the phosphorescent pigment in the composition. Preferably, the amount of the glass powder is from 20 to 80 wt.-%, particularly preferred from 25 to 75 wt.-%.

As the phosphorescent pigments, it is preferred to use inorganic phosphorescent pigments, particularly preferred nonradioactive inorganic phosphorescent pigments. The phosphorescent pigment may consist of one single pigment, but preferably it consists of mixtures of different pigments.

Phosphorescent pigments that are suitable according to the invention are in particular oxides of rare earth elements and sulfides, selenides, silicates, aluminates, fluo-aluminates, phosphates, halophosphates, borates, germanates, vanadates, molybdates and tungstates of preferably divalent metals, such as Zn, Mn, the earth alkali metals Be, Mg, Ca, Sr and Ba, and the rare earth metals, wherein the pigments may be present either as pure substance phosphors or doped with heavy metals, such as Bi, Sn, Cu, Tl, Al, Mn, Pb, and rare earth metals, in particular La, Ce, Pr, Nd, Sm, Eu, Gd, Dy, Tb, Ho, Er, Tm, Yb and Lu. It is particularly preferred that the composition according to the invention comprises at least one phosphorescent pigment, selected from sulfides, aluminates and silicates, doped with one or more heavy metals and/or rare earth metals. Examples of sulfides that are suitable according to the invention are ZnS, for instance doped with Cu (ZnS:Cu), CaS:Bi and CaCdS:Cu. Aluminates that are suitable according to the invention comprise the earth alkali aluminates, for instance those described in U.S. Pat. No. 5,424,006 A and U.S. Pat. No. 5,686,022. Phosphorescent pigments that are particularly suitable according to the invention are those comprising a compound of the general formula MAl₂O₄ wherein M represents at least one element, selected from Ca, Sr and Ba, or a compound of the formula M₁₋ₓAl₂O₄₋ₓ wherein M has the same meaning as above or a combination of these elements with Mg and x is within the range of −0.33≦x≦0.60 (except for x=0). Such earth alkali aluminates are doped with at least one rare earth metal, in particular europium (Eu) and/or dysprosium (Dy). Strontium aluminate doped with Eu and/or Dy (SrAl₂O₄:Eu,Dy) is particularly preferred. Examples of silicates that are suitable according to the invention are Zn₂SiO₄ and earth alkali silicates. A phosphorescent pigment comprising at least one of the above-described pigments based on a sulfide or an aluminate or mixtures thereof is in particular preferred. It turned out that compositions containing or consisting of pigments based on an aluminate, in particular an earth alkali aluminate, as the phosphorescent pigments enable an even longer stability and luminance of the products produced by such compositions. Suitable phosphorescent pigments are commercially available, for instance under the trade name Lumilux®.

According to a further embodiment, the phosphorescent pigment comprises at least one tungstate, wherein the phosphorescent pigment used is preferably a pigment mixture containing a tungstate. Examples of tungstates according to the invention are CaWO₄ and MgWO₄ with MgWO₄ being particularly preferred. Such a tungstate is generally used in an amount of from 0.0001 wt-% to 5 wt.-%, based on the total weight of the phosphorescent pigment. It turned out that by using a mixture of phosphorescent pigments containing tungstates, in particular MgWO₄, the brightness of the luminescence of the compositions according to the invention in the medium of appliance can be further improved.

The phosphorescent pigment may be a nonencapsulated or an encapsulated, i.e. covered, pigment or a mixture of nonencapsulated and encapsulated pigment. Encapsulated pigments are known to a person skilled in the art. Encapsulated pigments that are suitable according to the invention are covered for example with glass, plastics or SiO₂. Such encapsulated pigments have a higher heat and moisture resistance and are therefore in particular suitable when the composition is used under conditions of high temperature and/or moisture. Furthermore, encapsulated pigments have an increased UV resistance, are insoluble in organic solvents and are resistant to acids and aqueous media. Under these conditions, the content of encapsulated pigments of the total amount of the phosphorescent pigment is usually at least 5 wt.-%, preferably at least 10 wt.-%, particularly preferred at least 30 wt.-%, and can be up to 100 wt.-%.

The phosphorescent pigment in nonencapsulated or encapsulated form preferably has a particle size d100 of 500 μm, i.e. 100 wt.-% of the particles may have a particle size up to 500 μm. Preferably, the phosphorescent pigment has a particle size d100 of 350 μm. The phosphorescent pigment may also be a mixture of pigments having different particle size distributions. Preferably, the phosphorescent pigment comprises at least one pigment fraction having a particle size d50 between 1 and 100 μm, preferably between 1 and 80 μm. Mixtures of pigments having different average particle sizes lead on the one hand to a more uniform light impression and furthermore can be in particular advantageous so as to avoid a rapid sedimentation of the particles in a medium of appliance, for instance a binder for dyes and paints. As in the case of the glass powder, the particle sizes and particle size distributions can be determined in a conventional manner by means of screen analysis according to DIN 66165-1 and 66165-2.

The phosphorescent pigment is preferably contained in the composition according to the invention in an amount of from 85 to 15 wt.-%, based on the total weight of the glass powder and the phosphorescent pigment. Preferably, the amount of the phosphorescent pigment is from 80 to 20 wt.-%, particularly preferred from 75 to 25 wt.-%.

It is preferred that at least one of the phosphorescent pigments contained in the composition has a luminescence intensity after 10 minutes, determined in accordance with DIN 67510, of at least 3.0 mcd/m², preferably of at least 10 mcd/m², particularly preferred of at least 50 mcd/m².

It is further preferred that the composition according to the invention comprises at least one phosphorescent pigment having an emission wavelength λₘₐₓ (emission maximum) in a wavelength range of from 380 to 500 nm (violet to blue), a wavelength range of from 510 to 580 nm (green) or a wavelength range of from 590 to 750 nm (red). Phosphorescent pigments emitting in the green or in the blue range are for example Zn₂SiO₄:Mn, ZnS:Cu, SrAl₂O₄:Eu, BaAl₂O₄:Eu and CaAl₂O₄:Eu, a pigment emitting in the violet range is for example CaAl₂O₄:Eu,Nd and a phosphorescent pigment emitting in the red range is for example CaS:Eu,Tm. It is preferable to use pigments phosphorescing in the violet, blue and green range. It is preferred that at least one of the phosphorescent pigments emitting in the violet, blue or green range has a luminescence intensity, determined in accordance with DIN 67510, of at least 10 mcd/m², particularly preferred of at least 50 mcd/m², after 10 minutes, and at least one of the phosphorescent pigments emitting in the red range has a luminescence intensity of at least 3.0 mcd/m², particularly preferred of at least 4.0 mcd/m², after 10 minutes. Various color effects can be achieved by mixing different phosphorescent pigments. For instance, it is possible to also obtain a white luminescence by mixing of appropriately doped earth alkali aluminates and silicates, for instance such that emit in the blue, green and red range.

According to a further embodiment, the composition according to the invention further comprises a fluorescent pigment (daylight pigment) in addition the phosphorescent pigment. Fluorescent pigments mean such pigments that emit light only as long as they are irradiated with light, in particular UV light, i.e. the light emission regularly ceases within less than a thousandth part of a second after the irradiation. Suitable fluorescent pigments are preferably inorganic fluorescent pigments, such as oxysulfides of the rare earth metals, in particular yttrium oxysulfide doped with Eu (Y₂O₂S:Eu), as well as metal-doped sulfides, such as ZnS. The content of the fluorescent pigment in the composition is preferably at least 10 parts by weight fluorescent pigment per 100 parts by weight total mass of glass powder and phosphorescent pigment. The presence of such a fluorescent pigment enables a luminescence of the subject treated with the composition according to the invention also during the period of time when the phosphorescent pigment is charged and stores energy. The luminous effect thus occurs additionally under irradiation of the objects with UV containing light, depending on the pigment also only under certain frequencies. Fluorescent pigments may have different colourings at daylight. The daylight color and the fluorescent color occurring under irradiation with light of the activation frequency may be different or the same.

According to a further embodiment, the composition according to the invention may additionally comprise an effect imparting powder, for instance a metal powder, in particular a noble metal powder, such as gold and silver powder, and a magnetic powder, wherein the particle size d100 of the powder is preferably 500 μm, particularly preferred 200 μm. The presence of such a powder in combination with the phosphorescent and fluorescent effects leads to a particular appearance of the subjects treated with the composition, for instance to metallic effects.

The compositions according to the invention can be used for the preparation of paints and dyes. For this, the compositions that may contain colored or colorless, preferably colorless, glass powder are inserted in a customary binder for paints and dyes. Examples of suitable binders are natural resins and oils, chalk, glue and preferably binders on the basis of plastics, such as binders on the basis of alkyd resins, acryl and methacrylate resins, polyvinyl acetate copolymers, epoxide resins, polyurethanes and mixtures thereof. Where appropriate, the dye and paint compositions according to the invention contain customary organic solvents, for example aliphatic, cycloaliphatic or aromatic hydrocarbons, such as hexane, cyclohexane and xylol, mono- or multivalent alcohols, such as propane, n-butane, isubutane and glycol, glycol ether, such as butyl glycol, butyl diglycol, ethylene glycol and diethyl glycol, ketones, such as acetone and methyl ethyl ketone, and esters, such as butyl acetate, ethyl acetate and butyl glycol acetate, or they are existent as a dispersion in water. Where appropriate, the compositions contain further customary additives, such as hardening accelerators and plastizers. Binders on the basis of acryl resins are preferred. The compositions according to the invention are inserted in the binder in amounts corresponding to the amounts customary of other pigments for paints and dyes. The amounts to be inserted also depend on the desired effect and can be easily determined by a person skilled in the art by simple tests. Typically, the weight ratio of the phosphorescent composition to the binder is within the range of from 1:6 to 6:1, preferably of from 1:4 to 4:1.

The dyes and paints according to the invention are excellently suitable for coating of various support materials, for instance wood, natural and artificial stone, concrete and armored concrete, metals, plastics, textiles, paper, glass, ceramics, asphalt and enamel, onto which they can be applied in a customary manner, for instance by spraying, brushing or dipping. Where appropriate, the support can be provided first with a customary primer before the dyes and paints according to the invention are applied. It is preferred to use bright primers because then the luminous effect is exhibited at its best. The layer made of the dyes and paints according to the invention is usually provided with a clear coat as a cover layer or protective layer that is preferably at least partially UV permeable, for instance a two-component clear coat based on polyurethane, which protects the pigment layer against water and wear.

Furthermore, the compositions according to the invention are excellently suitable for coating of concrete surfaces wherein every type of concrete can be used, for instance construction site concrete, ready-mixed concrete, jetcrete, underwater concrete, rolled concrete, pun concrete, vacuum concrete, build up concrete, flooring concrete, porous concrete, fiber reinforced concrete, wet mix aggregate, practical concrete, self-compacting concrete, high-strength and ultrahigh-strength concrete, foam glass concrete, fair-faced concrete, asphaltic concrete, chipping concrete, polymer concrete and papercrete.

During the coating of concrete products, it is advantageously possible to use phosphorescent and fluorescent pigments simultaneously or both pigments can be used separately. Thereby, the concrete product glows upon irradiation with UV and in the darkness after the onset of twilight. It is an advantageous additional benefit that the light required for the fluorescent effect charges the phosphorescent pigments at the same time. One example for an application of a concrete product, prepared from coated luminous concrete, is the use as steps of a staircase for marking the edges of the steps. For doing so, the concrete products can be prepared for instance by a pigment glass composition according to the invention, which contains a fluorescence pigment having a daylight color of green and a UV fluorescent color of red. The pigment mixture used is UV stable and is therefore suitable for outdoor applications. The green daylight color arranges for the concrete step edges to serve as a guidance of view for the end of the steps of a staircase in the daytime and is hardly distinguishable from customary adhesive strips. When darkness arises, the staircase lighting is switched on, but wherein in addition to the standard lamps, UV lamps are used, too, or are added to the available lamps. Once the UV lamps are switched on, the fluorescent concrete stones illuminate in the red fluorescent color. Upon switching off the light, the luminous effect extinguishes and there remains the luminescence of the phosphorescent pigment. Thus, by using fluorescent pigments it is possible to achieve a strong luminous effect in the course of charging by means of artificial or natural light sources, if applicable.

Exemplary applications for producing subjects of coated concrete material include concrete pebble stones of various sizes, shapes and colors; concrete products for town and road construction, gardening and landscape construction in the form of surface systems, slabs of large scale, ecoplasters, terrace plates; building planks, prefabricated components, in particular prefabricated steps/staircases, roof concrete slabs, joists, pillars; shaped bricks, concrete furniture (such as benches, flower boxes, tables), swimming pool components (such as edge demarcations, starting blocks, jumping facilities), balconies and balcony components, covers (such as manhole covers, outlet cover plates, operating device markings at covers); clinker bricks; boundary fences (such as walls and plinth walls); enclosures of walls; partition walls; prefabricated building components, in particular outside walls, curbstones, partition elements, joists; roof constructions and roof prefabricated elements; parts of and complete ramps, sidewalks and open spaces and traffic areas as well as there boundaries or complete markings; parts of and complete obstacles including their markings; slope stabilization stones (L stones and the like); tribune safeguards, in particular markings of security relevant escape routes and guard rails, respectively, and/or other edge demarcations; supporting and non-supporting walls; and boundaries incorporated into floors. Moreover, concrete pebble stones coated with the paints and dyes according to the invention represent an environmentally friendly alternative to the commercially available “plastic stones”.

The compositions according to the invention are also excellently suitable for the preparation of plastic, paper, stone, glass and ceramic articles, wherein the composition according to the invention can be introduced into or applied onto the raw materials. The compositions according to the invention are in particular suitable for the preparation of glass and ceramic articles, in particular glass articles, such as glass rods, glass stones, glass spheres and glass tiles, wherein as regards the glass powder it is preferable to use at least partly colored glass powder. Here, the glass powder of the composition according to the invention may comprise colorless as well as colored glass. The glass articles, such as glass tiles, can be produced, as described for instance in DE 101 30 011 A. By doing so, a powder of the composition according to the invention is applied in a usual manner to a first glass portion, preferably a gob of viscous glass, for instance a glass blank of the desired size, subsequently a second glass portion covering the layer comprising the phosphorescent pigment, the second glass portion preferably being preferably also a gob of viscous glass, for instance a respective second glass blank, is applied to the first glass portion, preferably while the gob of the first glass portion is still in a viscous state, and is fused together with the first glass portion, thereby including the layer comprising the phosphorescent pigment. The presence of the glass powder in the composition according to the invention thereby enables a particularly good adherence between the respective glass portions.

The paints and dyes according to the invention, comprising the glass powder and the phosphorescent pigment, can thus be easily applied due to their stability and have excellent mechanic properties, such as wear resistance, pressure resistance, impact resistance, scratch resistance, acid resistance as well as slip resistance. It allows the coating of any surface and provides for manifold possibilities of appliance so that a cost-saving low-maintenance and flexible possibility is established to provide enduring markings and articles having a long duration of luminescence in a simple and uncomplicated manner.

The present invention will now be described in further detail by the following examples, which are not construed limiting for the present invention.

### EXAMPLES

### Comparative Example

100 g of a green phosphorescent pigment (Co. UV-Elements, Nordhausen, Germany) having a particle diameter of 25 to 70 μm were mixed with 150 g of a commercially available acryl resin as a binder. The thus obtained paint composition was uniformly sprayed on a cleaned, primed with a white dispersion paint, and dried aluminum plate (25×10 cm) by means of a spray pistol. After drying the first layer, the spraying step was repeated twice, wherein the individual layers were well dried in each case. Subsequently, sealing was carried out by means of a commercially available two-component clear coat with three layers.

The plate was exposed to daylight for 4 hours and then observed in a dark room. A dark green luminescence was observable that was visible for about 3 hours.

### Example 1

In parallel to the above experiment, 30 g of the green phosphorescent pigment (Co. UV-Elements, Nordhausen, Germany) and 70 g of a glass powder having a particle size d100 of 250 μm were mixed in the same acryl resin binder. The thus obtained paint composition was also uniformly sprayed on a cleaned, primed with a white dispersion paint, and dried aluminum plate (25×10 cm) by means of a spray pistol. After drying the first layer, the spraying step was repeated twice, wherein the individual layers were well dried in each case. Subsequently, sealing was carried out in the same manner as above by means of a commercially available two-component clear coat with three layers.

After exposure to light for 4 hours under the same conditions as above and observance in the dark room, a luminescence in a bright lime green was observed for 1.5 hours which was significantly brighter than the luminescence of the pigment without glass powder content. After fading of this bright luminescence, the standard luminescence of the pigment appeared, which remained visible for an additional 4 to 6 hours. At the same time, a brightening of the color tone visible at day was observed, which changed from yellow to whitish-yellow. The luminescence was more uniform with the fine-grained appearance than with the sample without glass powder.

The above experiments demonstrate that the presence of the glass powder results in a brighter luminescence than with a pigment without glass powder and that the total duration of luminescence prolongs. It can be assumed that this is to be attributed on the one hand to a reflection of the emitted radiation by the glass particles and on the other hand to a faster charging of the pigment in the presence of the glass particle. Moreover, the presence of the glass powder results in a brightening of the color tone visible at day. Furthermore, due to the different particle sizes of the glass powder and the pigment, the luminescence appears more uniformly and the pigments can be dispersed more stably and the paint can be applied better.

### Example 2

For the production of a slab of concrete of large scale, a mixture of white Portland cement and quartz sand was prepared, and a concrete was prepared from this mixture. After shaping, smoothing and optionally ball peening and coating with a first special paint layer for sealing the concrete surface, the concrete was sprayed by means of a low pressure, high volume painting device with a paint composition, as described in example 1 and blended with water. Depending on the layer thickness and the number of layers, the luminance was varied. After drying of this pigment glass layer, a protective paint was sprayed, wherein several layers thereof were applied in order to provide a protection as good as possible.

A slab of large scale was obtained that gives light at night after excitation by the daylight. At night, a recharging can be carried out by UV illumination in order to maintain the luminosity at a permanently high level. The top coat on the crystalline luminescent pigment glass layer on the concrete provides for a high wear resistance and for a long-lasting functionality of the slab. The slabs thus obtained luminesce in the dark for about 12 hours after a sufficient irradiation with sunlight or by artificial UV illumination. However, the duration of luminescence can be influenced by the choice of the pigment and the content of the glass.

### Example 3

### Preparation of Luminescent Concrete Pebbles

Irregular pebble stones were formed from the concrete mixture of example 2 by means of a drop process wherein the liquid concrete drips through a dosing aperture (drip ring) onto a conveyor belt (at different slope grades adjustable so as to achieve different rounding grades). After the drying step, the pebble stones were dropped onto a coarsely meshed screen (just as large so that the stones do not pass) and they were driven through a bath of the liquid luminescent pigment glass paint composition as used in example 2. Depending on the mixing ratio of the base medium, water and the utilized luminous mixture, different viscosities were obtained, which—in combination with the driving speed of the conveyor belt—resulted in different coating thicknesses, which in turn influenced the luminosity. After the drying step, a bath of the top coat was passed wherein again the conveyor belt speed determined the thickness of the protective paint.

The slabs thus obtained luminesced in the dark for about 12 hours after a sufficient irradiation with sunlight or by artificial UV illumination. The duration of luminescence could be influenced by the choice of the pigment and the content of the glass.

In the alternative, a high pressure, low volume device can be used for applying the pigment mixture and the top coat, wherein the conveyor belt has to be adjusted with oscillating movements for the rotation of the pebbles.

1-24. (canceled)

25. A phosphorescent composition, comprising:
(a) glass powder, the glass powder being lead-free glass powder, selected from lime soda glass, borosilicate glass, float glass and phosphate glass, wherein the glass powder has a particle size d100 of 350 μm; and
(b) phosphorescent pigment, wherein the phosphorescent pigment comprises at least one encapsulated phosphorescent pigment.

26. The composition according to claim 25, wherein the glass powder is selected from lime soda glass and borosilicate glass.

27. The composition according to claim 25, wherein the glass powder is contained in an amount of from 80 to 20 wt.-% and the phosphorescent pigment is contained in an amount of from 20 to 80 wt.-%, based on the total weight of glass powder and phosphorescent pigment.

28. The composition according to claim 25, wherein the phosphorescent pigment has a particle size d100 of 500 μm.

29. The composition according to any one of claim 25, wherein the phosphorescent pigment comprises at least one of a sulfide based phosphorescent pigment, aluminate based phosphorescent pigment, silicate based phosphorescent pigment or mixtures thereof.

30. The composition according to claim 25, wherein the phosphorescent pigment comprises at least one phosphorescent pigment having an emission wavelength λₘₐₓ in a wavelength range of from 380 to 500 nm, a wavelength range of from 510 to 580 nm or a wavelength range of from 590 to 750 nm.

31. The composition according to claim 25, wherein the encapsulated phosphorescent pigment is encapsulated with glass, plastics and/or SiO₂.

32. The composition according to claim 31, wherein the encapsulated pigment is contained in an amount of at least 5 wt.-%, based on the total weight of the phosphorescent pigment.

33. The composition according to claim 25, wherein the composition comprises a tungstate.

34. The composition according to claim 25, wherein the composition further comprises a fluorescent pigment.

35. The composition according to claim 34, wherein the fluorescent pigment is contained in an amount of at least 10 parts by weight per 100 parts by weight total mass of glass powder and phosphorescent pigment.

36. The composition according to claim 25, wherein the composition further comprises an effect imparting powder.

37. A dye or paint composition, comprising a binder as well as a phosphorescent composition according to claim 25.

38. The dye or paint composition according to claim 37, wherein the binder is a plastic based binder.

39. The dye or paint composition according to claim 37, wherein the binder is selected from alkyd resin based binders, acryl and methacrylate resin based binders, polyvinyl acetate copolymer based binders, epoxide resin based binders, polyurethane based binders and mixtures thereof.

40. Use of a composition according to claim 25 for producing luminescent articles.

41. The use according to claim 40, wherein the article is a glass article, in particular a glass rod, a glass stone, a glass sphere or a glass tile.

42. Use of a dye or paint composition according to claim 37 for coating stone and concrete products.

43. A process for producing a luminescent glass article, wherein a phosphorescent composition is applied to a first glass portion, thereafter a second glass portion covering the luminescent pigment layer is applied to the first glass portion, the second glass portion being fused together with the first glass portion thereby including the phosphorescent composition, characterized in that the phosphorescent composition as used is a composition according claim 25.

44. The process according to claim 43, wherein the first glass portion is a gob of viscous glass, to which the phosphorescent composition is applied, and which is covered while still in a viscous state with a gob forming the second glass portion.

45. The process according to claim 43, wherein the glass article is a glass rod, a glass stone, a glass sphere or a glass tile.
